(19) United States
(12) Patent Application Publication
(10) Pub. No.: US 2024/0077717 A1
(43) Pub. Date: Mar. 7, 2024

(54) SCANNING OPTICAL DEVICE

(71) Applicant: BROTHER KOGYO KABUSHIKI KAISHA, Nagoya (JP)

(72) Inventors: Junichi YOKOI, Nagoya (JP); Junichi HIRAOKA, Nagoya (JP)

(21) Appl. No.: 18/456,922

(22) Filed: Aug. 28, 2023

(30) Foreign Application Priority Data
Sep. 5, 2022 (JP) 2022-140796

(51) Int. Cl. G02B 26/12; G02B 7/182

(52) U.S. Cl. CPC G02B 26/121; G02B 7/1821; G02B 26/124

(57) ABSTRACT

A scanning optical device includes a semiconductor laser, a coupling lens, a polygon mirror, a motor circuit board, a cable harness, and a scanning optical system. The semiconductor laser is configured to emit light. The coupling lens is configured to convert the light emitted by the semiconductor laser into a light beam. The polygon mirror is configured to deflect the light beam converted by the coupling lens. The motor circuit board includes a motor configured to rotate the polygon mirror. The cable harness is configured to supply signals to the motor circuit board. The scanning optical system is configured to receive the light beam from the polygon mirror and to form an image on an image surface. The cable harness overlaps the light beam directed from the coupling lens toward the polygon mirror when viewed from an axial direction of a rotation axis of the polygon mirror.

### REFERENCE TO RELATED APPLICATIONS

This application claims priority from Japanese Patent Application No. 2022-140796 filed on Sep. 5, 2022. The entire content of the priority application is incorporated herein by reference.

### BACKGROUND ART

A scanning optical device including a polygon mirror is known.

### DESCRIPTION

A scanning optical device includes a light source, a polygon mirror for deflecting light from the light source, a motor circuit board having a motor for rotating the polygon mirror, and a cable harness for supplying signals to the motor circuit board. In this technique, the cable harness extends from the motor circuit board to the opposite side of the light source with respect to the polygon mirror.

However, in a case where a board for supplying signals to the motor circuit board via the cable harness is arranged on the light source side of the scanning optical device, a problem occurs that the wiring length of the cable harness increases.

In view of the foregoing, an example of an object of this disclosure is to reduce the wiring length of a cable harness that supplies signals to a motor circuit board of a scanning optical device.

According to one aspect, this specification discloses a scanning optical device. The scanning optical device includes a semiconductor laser, a coupling lens, a polygon mirror, a motor circuit board, a cable harness, and a scanning optical system. The semiconductor laser is configured to emit light. The coupling lens is configured to convert the light emitted by the semiconductor laser into a light beam. The polygon mirror is configured to deflect the light beam converted by the coupling lens. The motor circuit board includes a motor configured to rotate the polygon mirror. The cable harness is configured to supply signals to the motor circuit board. The scanning optical system is configured to receive the light beam from the polygon mirror and to form an image on an image surface. The cable harness overlaps the light beam directed from the coupling lens toward the polygon mirror when viewed from an axial direction of a rotation axis of the polygon mirror. Thus, the cable harness extends from the motor circuit board toward the semiconductor laser side. This reduces a wiring length in a configuration in which a board that supplies signals to the motor circuit board via the cable harness is arranged on the semiconductor laser side of the scanning optical device.

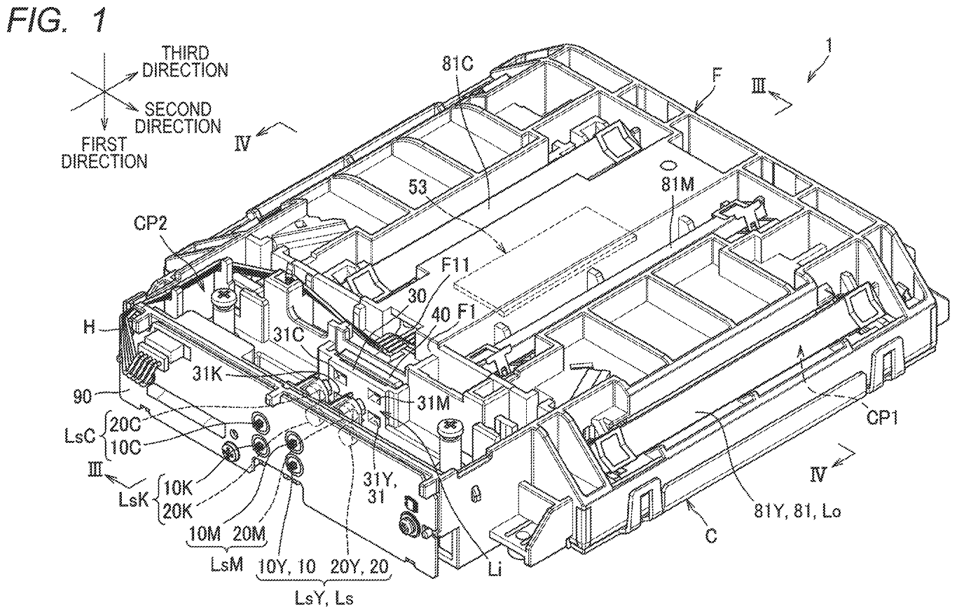

FIG. 1 is a perspective view of a scanning optical device viewed from an other side in a first direction.

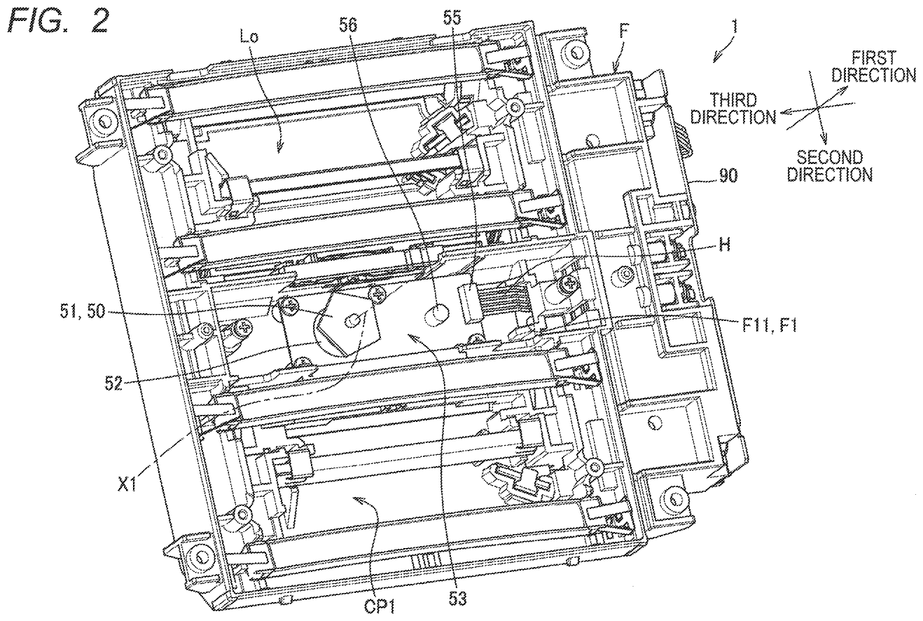

FIG. 2 is a perspective view of the scanning optical device viewed from one side in the first direction.

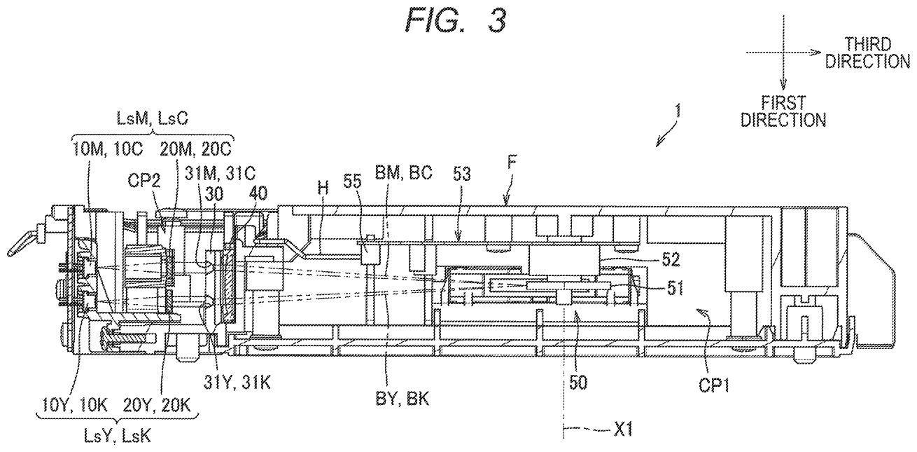

FIG. 3 is a cross-sectional view taken along a line III-III in FIG. 1.

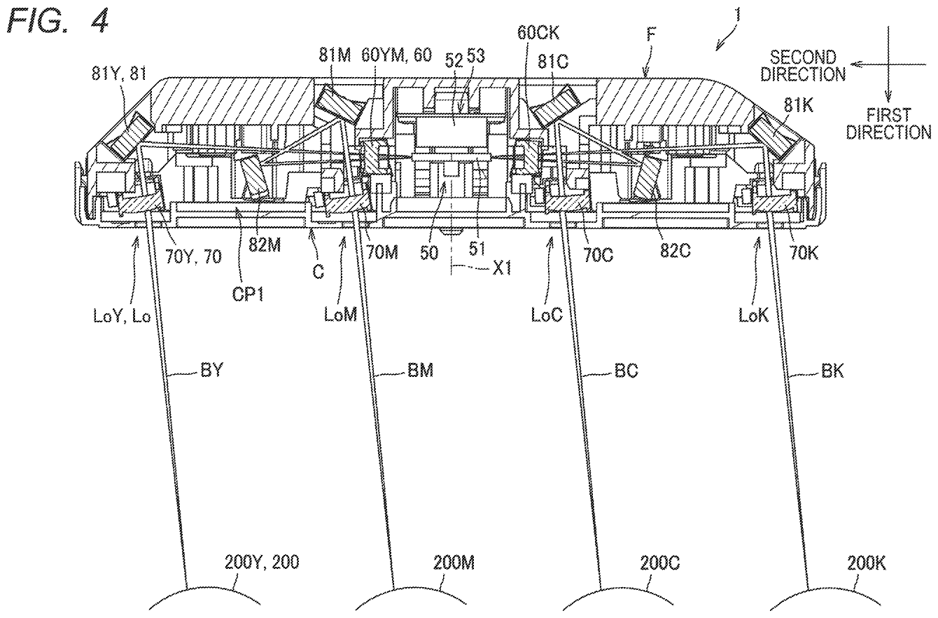

FIG. 4 is a cross-sectional view taken along a line IV-IV in FIG. 1.

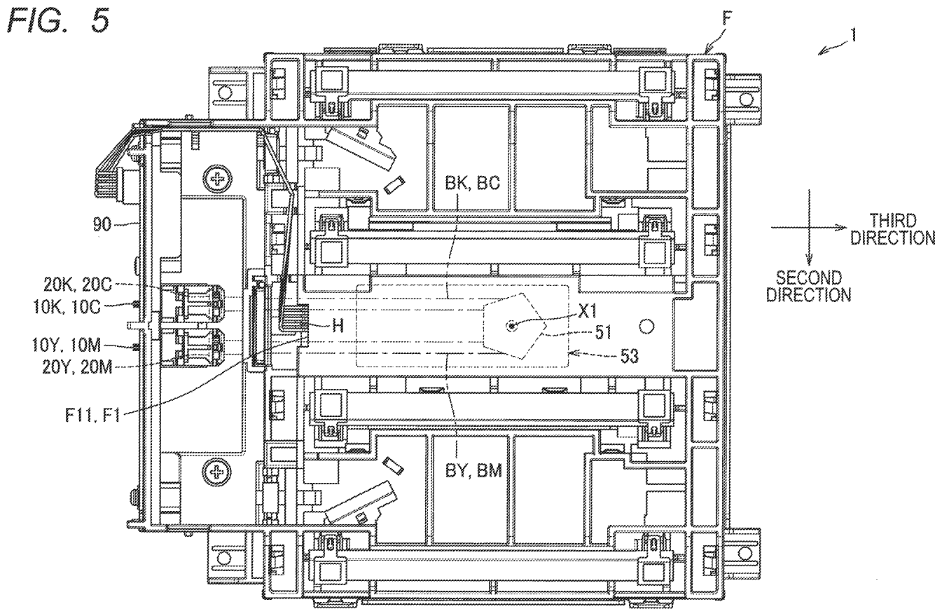

FIG. 5 is a plan view of the scanning optical device viewed from the other side in the first direction.

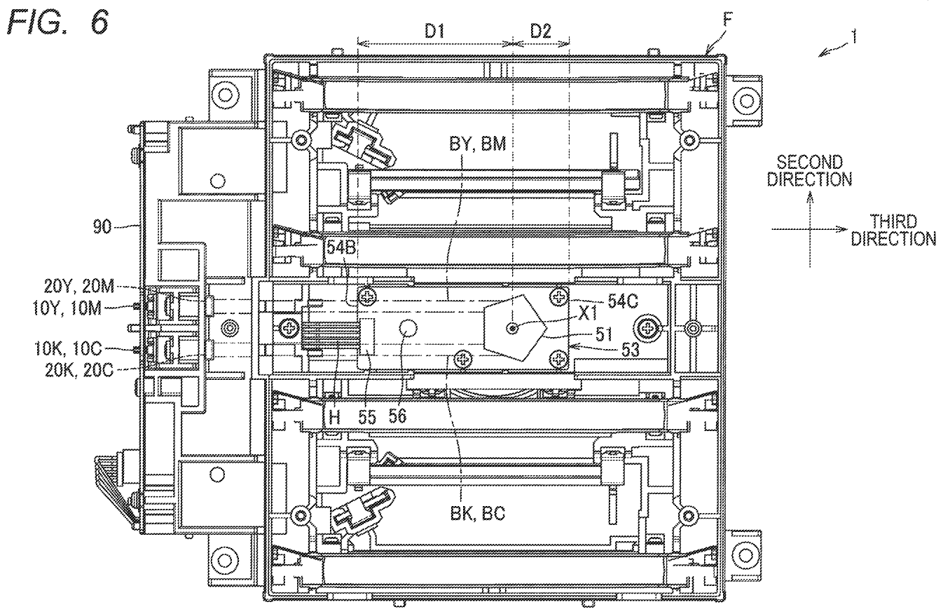

FIG. 6 is a plan view of the scanning optical device viewed from one side in the first direction.

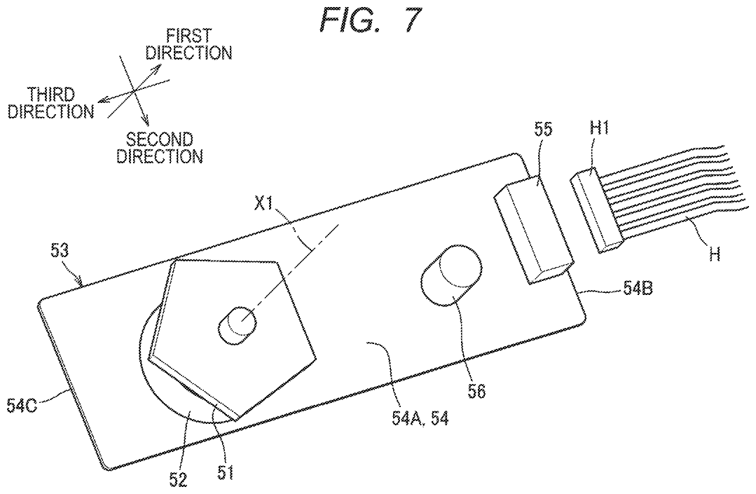

FIG. 7 is an exploded perspective view of a motor circuit board and a cable harness.

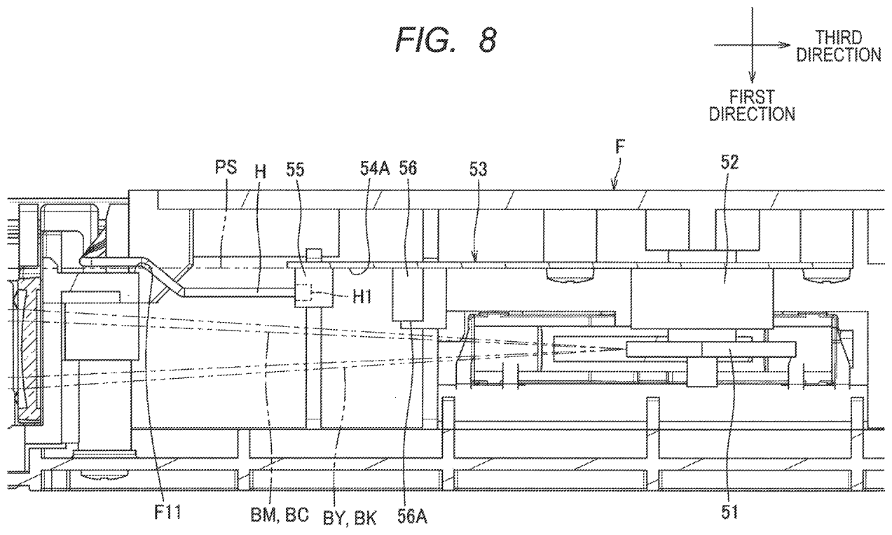

FIG. 8 is an enlarged cross-sectional view showing a structure around a motor circuit board in FIG. 3.

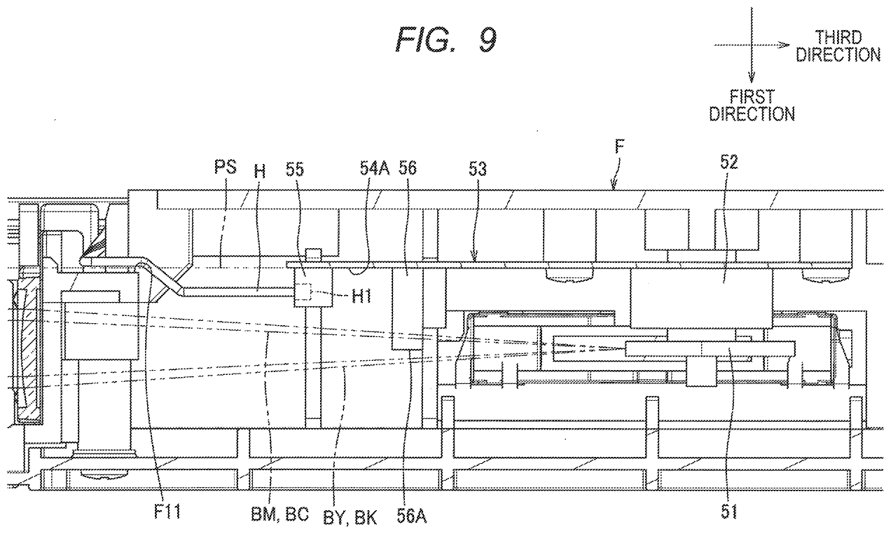

FIG. 9 is a cross-sectional view in which a height of a capacitor is increased.

As shown in FIGS. 1 and 2, a scanning optical device 1 includes a frame F, an incident optical system Li, an optical deflector 50, and a scanning optical system Lo. In this embodiment, the scanning optical device 1 is applied to an electrophotographic image forming apparatus. The image forming apparatus includes four photosensitive drums 200 (see FIG. 4).

In the following description, a direction parallel to a rotation axis X1 of a polygon mirror 51 described later is referred to as a “first direction”. A direction perpendicular to the first direction and in which the polygon mirror 51 and a first scanning lens 60 (see FIG. 4) are arranged is referred to as a “second direction”. A direction perpendicular to the first direction and the second direction is referred to as a “third direction”. The third direction corresponds to a main scanning direction, and the first direction corresponds to a sub-scanning direction of the incident optical system Li. It is assumed that an arrow showing each direction in drawings indicates one side in each direction.

The incident optical system Li includes four light sources Ls, an aperture plate 30, and a condenser lens 40. Each light source Ls is a device that emits a light beam, and includes a semiconductor laser 10 and a coupling lens 20.

The semiconductor laser 10 is a device that emits light. Four semiconductor lasers 10 are provided corresponding to the four photosensitive drums 200 (see FIG. 4) that are scanned and exposed by the scanning optical device 1. Toner images of different colors are formed on the photosensitive drums 200.

In this embodiment, a first color is “yellow (Y)”, a second color is “magenta (M)”, a third color is “cyan (C)”, and a fourth color is “black (K)”. In the following description, the name of the part corresponding to the first color may be prefixed with “first” and the part corresponding to the first color may be distinguished by adding “Y” to the end of the reference numeral. Similarly, the parts corresponding to the second, third, and fourth colors are prefixed with “second,” “third,” and “fourth,” and suffixed with “M, “C”, and “K” may be used for distinguishing.

The semiconductor lasers 10 include a first semiconductor laser 10Y corresponding to yellow, a second semiconductor laser 10M corresponding to magenta, a third semiconductor laser 10C corresponding to cyan, and a fourth semiconductor laser 10K corresponding to black. The first semiconductor laser 10Y is arranged with an interval in the first direction from the second semiconductor laser 10M. The first semiconductor laser 10Y is located on one side in the first direction with respect to the second semiconductor laser 10M.

The third semiconductor laser 10C is arranged with an interval in the second direction from the second semiconductor laser 10M. The third semiconductor laser 10C is located on the other side in the second direction with respect to the second semiconductor laser 10M. The fourth semiconductor laser 10K is arranged with an interval in the first direction from the third semiconductor laser 10C, and is arranged with an interval in the second direction from the first semiconductor laser 10Y.

The coupling lens 20 is a lens that converts light from the semiconductor laser 10 into a light beam. The coupling lenses 20Y, 20M, 20C and 20K for respective colors are arranged at positions facing corresponding semiconductor lasers 10Y, 10M, 10C and 10K.

The aperture plate 30 has stop apertures 31 through which the light beam from the coupling lens 20 passes. In this embodiment, the aperture plate 30 is formed integrally with the frame F. The aperture plate 30 is located between the coupling lens 20 and the condenser lens 40. Four stop apertures 31 are provided corresponding to the four semiconductor lasers 10 and coupling lenses 20.

The condenser lens 40 is a lens that condenses the light beam from the coupling lens 20 onto a mirror surface of the polygon mirror 51 in the sub-scanning direction. The condenser lens 40 is located on the side opposite to the coupling lens 20 with respect to the aperture plate 30.

As shown in FIG. 3, the optical deflector 50 is a device that deflects the light beam from the light source Ls in the main scanning direction (third direction), and includes the polygon mirror 51, a motor 52, and a motor circuit board 53. The polygon mirror 51 rotates to deflect the light beam in the main scanning direction. The polygon mirror 51 has five mirror surfaces provided at equal distances from the rotation axis X1 (see also FIG. 2). The motor 52 is a motor for rotating the polygon mirror 51. The motor circuit board 53 is provided with the motor 52. The motor circuit board 53 is fixed to the frame F.

As shown in FIG. 4, the scanning optical system Lo is an optical system that forms an image of the light beam deflected by the optical deflector 50 on the surface of the photosensitive drum 200 serving as an image surface. Each component constituting the scanning optical system Lo is fixed to the frame F. The scanning optical system Lo includes a first scanning optical system LoY corresponding to yellow, a second scanning optical system LoM corresponding to magenta, a third scanning optical system LoC corresponding to cyan, and a fourth scanning optical system LoK corresponding to black.

The first scanning optical system LoY and the second scanning optical system LoM are arranged on one side of the polygon mirror 51 in the second direction. The third scanning optical system LoC and the fourth scanning optical system LoK are arranged on the other side of the polygon mirror 51 in the second direction. A light beam from the optical deflector 50 is incident on each of the scanning optical systems LoY, LoM, LoC, and LoK.

The first scanning optical system LoY includes a first scanning lens 60YM, a second scanning lens 70Y, and a reflecting mirror 81Y.

The first scanning lens 60YM is a lens that refracts light beams BY and BM deflected by the optical deflector 50 in the main scanning direction and forms images on the photosensitive drums 200Y and 200M. The first scanning lens 60YM has an fθ characteristic that causes the light beams BY and BM scanned at a constant angular velocity by the optical deflector 50 to have a constant velocity on the photosensitive drums 200Y and 200M.

The reflecting mirror 81Y is a mirror that reflects the light beam BY from the first scanning lens 60YM toward the photosensitive drum 200Y.

The second scanning lens 70Y is a lens that refracts the light beam BY reflected by the reflecting mirror 81Y in the sub-scanning direction and forms an image on the photosensitive drum 200Y In the scanning optical system Lo, the sub-scanning direction corresponds to the direction perpendicular to the main scanning direction and a light beam traveling direction. The second scanning lens 70Y is arranged on one side of the polygon mirror 51 in the first direction.

The second scanning optical system LoM includes the first scanning lens 60YM, a second scanning lens 70M, a reflecting mirror 81M, and a mirror 82M.

The first scanning lens 60YM is shared with the first scanning optical system LoY The mirror 82M is a mirror that reflects the light beam BM from the first scanning lens 60YM to the reflecting mirror 81M. The second scanning lens 70M and the reflecting mirror 81M have similar functions to the second scanning lens 70Y and the reflecting mirror 81Y of the first scanning optical system LoY That is, the reflecting mirror 81M reflects the light beam BM reflected by the mirror 82M toward the photosensitive drum 200M, and the second scanning lens 70M refracts the light beam BM reflected by the reflecting mirror 81M in the sub-scanning direction and forms an image on the photosensitive drum 200M.

The third scanning optical system LoC has a structure that is substantially symmetrical with the second scanning optical system LoM with respect to the rotation axis X1 of the polygon mirror 51. Specifically, the third scanning optical system LoC includes a first scanning lens 60CK, a second scanning lens 70C, a reflecting mirror 81C, and a mirror 82C that have functions similar to the members of the second scanning optical system LoM.

The first scanning lens 60CK refracts light beams BC and BK deflected by the optical deflector 50 in the main scanning direction to form images on the photosensitive drums 200C and 200K. The mirror 82C reflects the light beam BC from the first scanning lens 60CK to the reflecting mirror 81C. The reflecting mirror 81C reflects the light beam BC reflected by the mirror 82C toward the photosensitive drum 200C. The second scanning lens 70C refracts the light beam BC reflected by the reflecting mirror 81C in the sub-scanning direction to form an image on the photosensitive drum 200C.

The fourth scanning optical system LoK has a structure that is substantially symmetrical with the first scanning optical system LoY with respect to the rotation axis X1 of the polygon mirror 51. Specifically, the fourth scanning optical system LoK includes the first scanning lens 60CK, a second scanning lens 70K, and a reflecting mirror 81K that have functions similar to the members of the first scanning optical system LoY.

The reflecting mirror 81K reflects a light beam BK from the first scanning lens 60CK toward the photosensitive drum 200K. The second scanning lens 70K refracts the light beam BK reflected by the reflecting mirror 81K in the sub-scanning direction to form an image on the photosensitive drum 200K.

As shown in FIG. 3, the light emitted from each of the semiconductor lasers 10Y, 10M, 10C and 10K passes through the corresponding coupling lenses 20Y, 20M, 20C and 20K to be converted into light beams BY, BM, BC and BK. The light beams BY, BM, BC, and BK pass through the corresponding stop apertures 31Y, 31M, 31C and 31K of the aperture plate 30, pass through the condenser lens 40, and are incident on the polygon mirror 51. The condenser lens 40 is a lens through which all of the light beams BY, BM, BC, and BK pass, and has a cylindrical entrance surface and a flat exit surface.

As shown in FIG. 4, the polygon mirror 51 deflects the light beams BY, BM, BC and BK toward the corresponding scanning optical systems LoY, LoM, LoC and LoK. The light beam BY directed toward the first scanning optical system LoY passes through the first scanning lens 60YM, is reflected by the reflecting mirror 81Y, passes through the second scanning lens 70Y, and is emitted toward the photosensitive drum 200Y on one side in the first direction. The light beam BY is emitted from the second scanning lens 70Y at a particular angle with respect to the first direction. The light beam BY is imaged on the surface of the first photosensitive drum 200Y and is scanned in the main scanning direction.

The light beam BM directed toward the second scanning optical system LoM passes through the first scanning lens 60YM, is reflected by the mirror 82M and the reflecting mirror 81M, passes through the second scanning lens 70M, and is emitted toward the photosensitive drum 200M on one side in the first direction. The light beam BM is emitted from the second scanning lens 70M at a particular angle with respect to the first direction. The light beam BM is imaged on the surface of the second photosensitive drum 200M and is scanned in the main scanning direction. The light beams BC and BK are similarly emitted toward the photosensitive drums 200C and 200K on one side in the first direction by the corresponding scanning optical systems LoC and LoK, and are imaged on the surfaces of the corresponding photosensitive drums 200C and 200K and are scanned in the main scanning direction.

The frame F is made of resin and integrally formed by molding. The frame F has a first recess CP1 shown in FIG. 2 and a second recess CP2 shown in FIG. 1. The first recess CP1 is recessed from an end of the frame F on one side in the first direction and opens on the one side in the first direction. The second recess CP2 is recessed from an end of the frame F on the other side in the first direction and opens on the other side in the first direction. As shown in FIG. 4, the optical deflector 50 and part of the scanning optical system Lo are arranged in the first recess CP1. Specifically, the members of the scanning optical system Lo other than the reflecting mirrors 81 are arranged in the first recess CP1. As shown in FIG. 1, the coupling lens 20, the aperture plate 30, and the condenser lens 40 are arranged inside the second recess CP2. The second recess CP2 is arranged on the other side in the third direction with respect to the first recess CP1.

The frame F includes a wall F1 between the polygon mirror 51 and the coupling lens 20. The wall F1 is located between the first recess CP1 and the second recess CP2. The wall F1 constitutes part of a side surface of the first recess CP1. The wall F1 has an opening F11.

The scanning optical device 1 further includes a laser circuit board 90 and a cable harness (wiring harness) H. The laser circuit board 90 is located at the end of the frame F on the other side in the third direction. The laser circuit board 90 is located on the side opposite to the polygon mirror 51 with respect to the coupling lens 20 in the third direction. The semiconductor lasers 10Y, 10M, 10C, and 10K are mounted to the laser circuit board 90.

Although not shown, the image forming apparatus includes a main board electrically connected to the laser circuit board 90. For example, the main board is located on the other side in the third direction with respect to the scanning optical device 1 in the main housing of the image forming apparatus.

The cable harness H is wiring for supplying electric power and signals from the laser circuit board 90 to the motor circuit board 53. The cable harness H includes five electric cables, for example. The cable harness H is connected to the laser circuit board 90 and the motor circuit board 53. The cable harness H extends from the motor circuit board 53 toward the coupling lens 20 in the third direction. The cable harness H extending from the motor circuit board 53 to the other side in the third direction enters the second recess CP2 through the opening F11 of the wall F1.

The cable harness H entering the second recess CP2 from the opening F11 is bent toward the other side in the second direction, and extends along the surface of the second recess CP2 on one side in the third direction. Then, the cable harness H is bent to the other side in the third direction and extends along the surface of the second recess CP2 on the other side in the second direction. Then, the cable harness H penetrates through a wall forming the surface of the second recess CP2 on the other side in the third direction, is bent into a substantially U shape, and is connected to the laser circuit board 90.

As shown in FIGS. 5 and 6, when viewed from the first direction, a light beam (for example, BY) emitted from one coupling lens and a light beam (for example, BK) emitted from another coupling lens are separated from each other. Specifically, when viewed from the first direction, the light beam BY, BM emitted from the coupling lens 20Y, 20M located on one side in the second direction and the light beam BK, BC emitted from the coupling lens 20K, 20C located on the other side in the second direction are separated from each other in the second direction.

A portion of the cable harness H extending from the motor circuit board 53 in the third direction overlaps the light beam BC, BK directed toward the polygon mirror 51 from the coupling lens 20C, 20K located on the other side in the second direction, when viewed from the first direction, that is, the axial direction along the rotation axis X1 of the polygon mirror 51. In this embodiment, one of the five electric cables constituting the cable harness H overlaps the light beam BC, BK. The portion of the cable harness H extending from the motor circuit board 53 in the third direction does not overlap the light beam BY, BM directed toward the polygon mirror 51 from the coupling lens 20Y, 20M located on one side in the second direction, when viewed from the first direction.

As shown in FIG. 7, the motor circuit board 53 further includes a board main body 54, a board-side connector 55, and a capacitor 56, in addition to the motor 52 described above. The board main body 54 is a plate-like member, and has a board surface 54A, a first end 54B, and a second end 54C.

The board surface 54A is a surface perpendicular to the first direction. The board surface 54A is a surface on one side of the board main body 54 in the first direction. As shown in FIG. 8, an imaginary plane PS extending from the board surface 54A passes through the opening F11. That is, the board surface 54A is located within the range of the opening F11 with respect to the first direction.

As shown in FIG. 6, the first end 54B is closer to the coupling lens 20 than the rotation axis X1 is. The second end 54C is farther from the coupling lens 20 than the rotation axis X1 is. In the third direction, a distance D1 from the first end 54B to the rotation axis X1 is greater than a distance D2 from the second end 54C to the rotation axis X1.

As shown in FIG. 7, the board-side connector 55 is a connector to which a harness-side connector H1 attached to the end of the cable harness H is connected. The board-side connector 55 is located at the first end 54B of the board main body 54. The board-side connector 55 protrudes from the board surface 54A. The board-side connector 55 enables the harness-side connector H1 to be attached from a direction parallel to the board surface 54A. As shown in FIG. 8, the position where the harness-side connector H1 and the board-side connector 55 are connected is located on one side in the first direction with respect to the end of the opening F11 on the one side in the first direction.

The capacitor 56 is a cylindrical electronic component constituting part of the driving circuit of the motor 52, and protrudes from the board surface 54A. The capacitor 56 is the tallest electronic component among a plurality of electronic components arranged on the other side of the polygon mirror 51 in the third direction on the board surface 54A. In other words, the amount of protrusion of the capacitor 56 from the board surface 54A is larger than the amount of protrusion from the board surface 54A of each of the plurality of electronic components described above. For example, the amount of protrusion of the capacitor 56 from the board surface 54A is larger than the amount of protrusion of the board-side connector 55 from the board surface 54A. In FIG. 7 and so on, only the board-side connector 55 and the capacitor 56 among the plurality of electronic components are illustrated, and other electronic components are omitted.

As shown in FIG. 6, the capacitor 56 is located between two light beams (for example, BY and BK) separated from each other in the second direction when viewed from the first direction. As shown in FIG. 8, the plurality of light beams BY, BM, BC, and BK do not overlap the capacitor 56 when viewed from the second direction.

In other words, the capacitor 56 has a tip 56A located opposite to the board surface 54A. The plurality of light beams BY, BM, BC, and BK pass one side of the tip 56A of the capacitor 56 in the first direction.

As described above, according to this embodiment, the following effects are obtained. As shown in FIG. 6, the cable harness H is located at a position to overlap the light beam BK, BC directed from the coupling lens 20 toward the polygon mirror 51 when viewed from the first direction. Thus, the cable harness H extends from the motor circuit board 53 toward the semiconductor laser 10 side. This reduces the wiring length in the configuration in which the laser circuit board 90 that supplies signals to the motor circuit board 53 via the cable harness H is arranged on the semiconductor laser 10 side of the scanning optical device 1.

As shown in FIG. 8, the harness-side connector H1 is attachable to the board-side connector 55 from a direction parallel to the board surface 54A. Thus, the cable harness H extends in a direction parallel to the board surface 54A of the motor circuit board 53. Due to this configuration, the cable harness H is separated from the optical path of the light beam, which suppresses the light beam hitting the cable harness H.

Since the board surface 54A is located within the range of the opening F11 in the first direction, the cable harness H is allowed to pass through the opening F11 without being bent greatly.

As shown in FIG. 1, since the cable harness H is connected to the laser circuit board 90, the wiring length of the cable harness H is reduced. In the configuration in which the main board in the main housing of the image forming apparatus and the motor circuit board 53 are electrically connected, the laser circuit board 90 forms part of the electrical path from the motor circuit board 53 to the main board.

As shown in FIG. 6, the distance D1 from the first end 54B of the motor circuit board 53 to the rotation axis X1 is greater than the distance D2 from the second end 54C to the rotation axis X1. Thus, the portion of the motor circuit board 53 with the longer length from the rotation axis X1 is arranged on the incident light path side, and the space on the incident light path side of the rotation axis X1 is effectively utilized, which reduces the size of the scanning optical device 1.

Since the capacitor 56 is located between two light beams separated from each other when viewed from the first direction, the capacitor 56 is separated from the two light beams, thereby suppressing the light beam hitting the capacitor 56.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below. In the following description, members having substantially the same structure as those of the above-described embodiment are denoted by the same reference numerals, and descriptions thereof are omitted.

In the above embodiment, the capacitor 56 is configured to have a height that does not overlap the light beams BY, BM, BC, and BK when viewed from the second direction, but the present disclosure is not limited to this. For example, as shown in FIG. 9, the capacitor 56 may be configured to have a height overlapping the light beam BM, BC when viewed from the second direction. In other words, in the embodiment of FIG. 9, two light beams BM, BC of the plurality of light beams BY, BM, BC, and BK pass between the tip 56A of the capacitor 56 and the board surface 54A in the first direction.

According to this configuration, although the capacitor 56 overlaps the light beam BM, BC when viewed from the second direction, the capacitor 56 is located between two light beams separated in the second direction as shown in FIG. 6, thereby suppressing the light beam hitting the capacitor 56.

The semiconductor laser 10 may be configured to have a plurality of light emitting points. With this configuration, a plurality of light beams emitted from the semiconductor laser 10 may be converted into a plurality of light beams by one coupling lens 20, and the plurality of light beams may be imaged on the surface of the photosensitive drum 200 by the corresponding scanning optical system Lo. When configured in this manner, each of the light beams BY, BM, BC, and BK of the above embodiment includes a plurality of light beams.

In the embodiment, the cable harness H is composed of a plurality of independent electric cables. Alternatively, an electric cable in which a plurality of electric cables are bundled may be used. Alternatively, a flexible flat cable in which a plurality of wirings are provided on a flexible insulating body may be used.

In the above-described embodiment, the scanning optical device applied to a color image forming apparatus is exemplified. However, the scanning optical device may be applied to a monochrome image forming apparatus that scans one light beam.

The elements described in the above-described embodiment and modifications may be implemented in any combination.

What is claimed is:

1. A scanning optical device comprising:
a semiconductor laser configured to emit light;
a coupling lens configured to convert the light emitted by the semiconductor laser into a light beam;
a polygon mirror configured to deflect the light beam converted by the coupling lens;
a motor circuit board including a motor configured to rotate the polygon mirror;
a cable harness configured to supply signals to the motor circuit board; and
a scanning optical system configured to receive the light beam from the polygon mirror and to form an image on an image surface,
the cable harness overlapping the light beam directed from the coupling lens toward the polygon mirror when viewed from an axial direction of a rotation axis of the polygon mirror.

2. The scanning optical device according to claim 1, wherein the motor circuit board includes:
a board surface perpendicular to the axial direction; and
a board-side connector to which a harness-side connector is connected, the harness-side connector being attached to an end of the cable harness; and
wherein the harness-side connector is connectable to the board-side connector from a direction parallel to the board surface.

3. The scanning optical device according to claim 2, further comprising a frame including a wall between the polygon mirror and the coupling lens,
wherein the wall has an opening through which the cable harness passes.

4. The scanning optical device according to claim 3, wherein an imaginary plane extending from the board surface passes through the opening.

5. The scanning optical device according to claim 1, further comprising a laser circuit board to which the semiconductor laser is mounted,
wherein the cable harness is connected to the laser circuit board.

6. The scanning optical device according to claim 1, wherein the cable harness extends from the motor circuit board toward the coupling lens.

7. The scanning optical device according to claim 1, wherein the motor circuit board includes:
a first end closer to the coupling lens than the rotation axis is; and
a second end farther from the coupling lens than the rotation axis is; and
wherein a distance from the first end to the rotation axis is greater than a distance from the second end to the rotation axis.

8. The scanning optical device according to claim 1, wherein the semiconductor laser is a one-side semiconductor laser;
wherein the coupling lens is a one-side coupling lens;
wherein the scanning optical device further comprises:
an other-side semiconductor laser located away from the one-side semiconductor laser in a direction perpendicular to the light beam when viewed from the axial direction;
an other-side coupling lens configured to convert light emitted by the other-side semiconductor laser into a light beam; and
a capacitor protruding in the axial direction from the motor circuit board; and
wherein, when viewed from the axial direction, the capacitor is located between the light beam directed from the one-side coupling lens toward the polygon mirror and the light beam directed from the other-side coupling lens toward the polygon mirror.

9. The scanning optical device according to claim 8, wherein the capacitor includes a tip located opposite to the motor circuit board; and
wherein at least one of a plurality of light beams passes between the motor circuit board and the tip of the capacitor with respect to the axial direction.

10. The scanning optical device according to claim 1, wherein the image surface is a circumferential surface of a photosensitive drum provided in an image forming apparatus.

11. The scanning optical device according to claim 1, further comprising a frame having a first recess and a second recess, the first recess opening on one side in the axial direction, the second recess opening on an other side in the axial direction,
wherein the polygon mirror is disposed in the first recess; and
wherein the coupling lens is disposed in the second recess.

12. The scanning optical device according to claim 11, wherein the frame includes a wall located between the first recess and the second recess; and
wherein the wall has an opening through which the cable harness passes.
